(19) United States
(12) Patent Application Publication
(10) Pub. No.: US 2018/0104023 A1
(43) Pub. Date: Apr. 19, 2018

(54) Advanced Orthodontic Retainer

(71) Applicant: Brock Aaron Goodman, Las Vegas, NV (US)

(72) Inventor: Brock Aaron Goodman, Las Vegas, NV (US)

(21) Appl. No.: 15/294,201

(22) Filed: Oct. 14, 2016

(51) Int. Cl. A61C 7/08; B29C 51/42

(52) U.S. Cl. CPC A61C 7/08; B29L 2031/753; B29C 51/42

(57) ABSTRACT

An advanced thermoplastic orthodontic retainer is disclosed. The prior art includes a clear piece of thermoplastic material of uniform thickness which is then heated to a soft state and adapted to a stone model of a patient's teeth. The present invention incorporates a gradient of thickness of the plastic running from one end to the other. This gradient will exist in the final retainer, and it will take into account the normal pattern of opening and closing of the jaw during which the posterior segment is open less than the anterior segment when the teeth are close to contacting. The present invention retains the ease of fabrication, low cost, and aesthetics of the currently prescribed removable appliance while improving the durability and functionality. Dentists and orthodontists can use the present invention to prevent the unwanted side effects of the prior art including but not limited to posterior open-bites.

### FIELD OF THE INVENTION

This invention relates to a dental retention device, also called a dental retainer, for use in patients who have undergone orthodontic treatment, or for some other reason need to have pairs of teeth or groups of teeth retained, or stabilized, in the lower and/or upper jaw(s).

### BACKGROUND OF THE INVENTION

Orthodontic treatment does not end when the braces are taken off. Orthodontic retainers are custom-made devices, usually made of wires or clear plastic that holds teeth in position after orthodontic treatment. Most orthodontic patients are required to wear their retainer(s) every night at first, with many also being directed to wear them during the day—at least initially.

An Essix® retainer is one common type of orthodontic retainer. Essix® style orthodontic appliances are also sometimes referred to as “invisible” retainers because they're made using clear plastic. They may also be referred to as “overlay” retainers because they fully cover over the teeth. They were first introduced in the early 1970's. These are vacuum-formed appliances that are relatively simple and relatively inexpensive to make. Many dentists fabricate them right in their own office. An impression of the patient's teeth is taken and transformed into a plaster cast. A thin sheet of plastic (around 0.030 inch) is then heated and using a vacuum unit is sucked down over the cast (thus creating the needed shape for the retainer). The excess plastic is trimmed away. The finished appliance may cover all of the patient's teeth on the arch (upper or lower jaw) or else just some grouping of them.

The Essix® retainer is a name most modern dental offices are familiar with, but it's really a brand of vacuum-formed retainers. Essix® retainers are one brand of plastic retainers. Vacuum-formed, or Essix® retainers, are both removable and less visible than Hawley retainers. Vacuum-formed retainers are totally clear. They cover all sides of the teeth including the cheek side, tongue side and chewing surface. There are no wires, and the appliances can be removed, so they don't interfere with eating or oral hygiene. Some patients find the clear appearance more appealing, although another advantage of the Essix® retainer is that it may also only need to be worn full time for a short period of time. These retainers are also less expensive to fabricate than the other types of retainers.

Orthodontic treatment results are potentially unstable, and therefore retention is necessary, for three major reasons: (1) the gingival and periodontal tissues are affected by orthodontic tooth movement and require time for reorganization when the appliances are removed; (2) the teeth may be in an inherently unstable position after the treatment, so that soft tissue pressures constantly produce a relapse tendency; and (3) changes produces by growth may alter the orthodontic treatment result. Retention cannot be abandoned until growth is completed if the orthodontic treatment result is expected to be maintained.

Widening of the periodontal ligament space and disruption of the collagen fiber bundles that support each tooth are normal responses to orthodontic treatment. In fact, these changes are necessary to allow orthodontic tooth movement to occur. Even if tooth movement stops before the orthodontic appliance is removed, restoration of the normal periodontal architecture will not occur as long as a tooth is strongly splinted to its neighbors, as when it is attached to a rigid orthodontic arch wire. Once the teeth can respond individually to the forces of mastication (i.e. once each tooth can be displaced slightly relative to its neighbor as the patient chews), reorganization of the periodontal ligament occurs over a 3- to 4-month period, and the slight mobility present at appliance removal disappears.

Relapse into anterior open bite can occur by any combination of depression of the incisors and elongation of the molars. In patients who do not place some object between the front teeth (i.e. thumb sucking), return of open bite is almost always the result of elongation of the posterior teeth, particularly the upper molars, without any evidence of intrusion of incisors. Controlling eruption of the upper molars therefore is the key to retention in open bite patients.

A common retainer for open bite patients is an appliance with bite blocks between the posterior teeth that creates several millimeters of jaw separation. This stretches the patient's soft tissues to provide a force opposing eruption. Excessive vertical growth and eruption of the posterior teeth often continue until late in the teens or early twenties, making a persistent open bite tendency difficult to control, but this can be accomplished with good patient cooperation over a long enough period.

Cephalometric analysis is the use of linear and angular measurements taken on cephalometric radiographs. One commonly used angular measurement is the Frankfurt-mandibular plane angle. This is the angle created by the intersection of the Frankfort Horizontal and the mandibular plane. This angle is important in orthodontics as it is well understood that it represents a natural jaw position determined by factors such as the anatomy of the facial musculature and skeletal structures. Because the musculoskeletal matrix that determines the Frankfurt-mandibular plane angle does not have a tendency to change due to orthodontic therapy, neither does the angle. If for example, cement is placed on the occlusal surface of a molar, at first the bite will open with the occlusion resting only on that molar. Overtime the musculoskeletal matrix will place forces on that molar until it intrudes only to the point that the Frankfurt-mandibular plane angle has been re-established. The molar will have been intruded and the rest of the bite restored to normal. The same occurs when thermoplastic retainers of even thickness cover the teeth. While wear the retainer, the majority of the occlusion occurs on the posterior teeth. This results in the stretching of the soft tissue matrix. When the patient removes the retainer to eat (or otherwise) the posterior teeth no longer properly contact. Many orthodontists choose not to use these types of retainers due to their tendency to cause a posterior open bite problem. As well, these types of retainers are not durable because of the uneven distribution of forces on the posterior portion of the retainer. This uneven distribution of forces causes wear to the posterior portion of the retainer and flexion to the anterior portion of the retainer. This can result in early breakage of the retainer.

There exists an un-met need for a thermoplastic orthodontic retainer that retains the ease of fabrication, low cost, and aesthetics of the currently prescribed removable thermoplastic orthodontic retainers while improving the durability. As well, dentists and orthodontists have an unmet need for a thermoplastic orthodontic retainer that prevents the unwanted posterior open bites and other negative side effects of currently available thermoplastic removable orthodontic retainers.

### SUMMARY OF THE INVENTION

The present invention incorporates a gradient of thickness of the thermoplastic material running from one end to the other. This gradient will exist in the final retainer, and it will take into account the normal pattern of opening and closing of the jaw during which the posterior segment is open less than the anterior segment when the teeth are close to contacting. The present invention retains the ease of fabrication, low cost, and aesthetics of the currently prescribed removable appliance while improving the durability and functionality. The retainer of the present invention will cause no posterior open bite problem. The present invention is more durable because the contact between the upper and lower retainers is uniform rather than concentrated on the anterior or posterior bite surface. Dentists and orthodontists can use the present invention to prevent the unwanted side effects of the prior art including but not limited to posterior open-bites.

The present invention also includes a method of fabricating this thermoplastic removable orthodontic retainer customized to the patient's case.

### ADVANTAGES OF THE INVENTION

### BRIEF DESCRIPTION OF THE DRAWINGS

FIG. 1 shows a top view of the thermoplastic sheet of the prior art

FIG. 2 shows a perspective view of a thermoplastic sheet of the prior art.

FIG. 3 shows a perspective view of an embodiment of the present invention wherein the thermoplastic sheet is rectangular and the gradient is uniform.

FIG. 4 shows a perspective view of an embodiment of the present invention wherein the thermoplastic sheet is circular and the gradient is uniform.

FIG. 5 shows a perspective view of an embodiment of the present invention wherein the thermoplastic sheet is rectangular and the gradient is non-uniform.

FIG. 6 shows a perspective view of an embodiment of the present invention wherein the thermoplastic sheet is circular and the gradient is non-uniform.

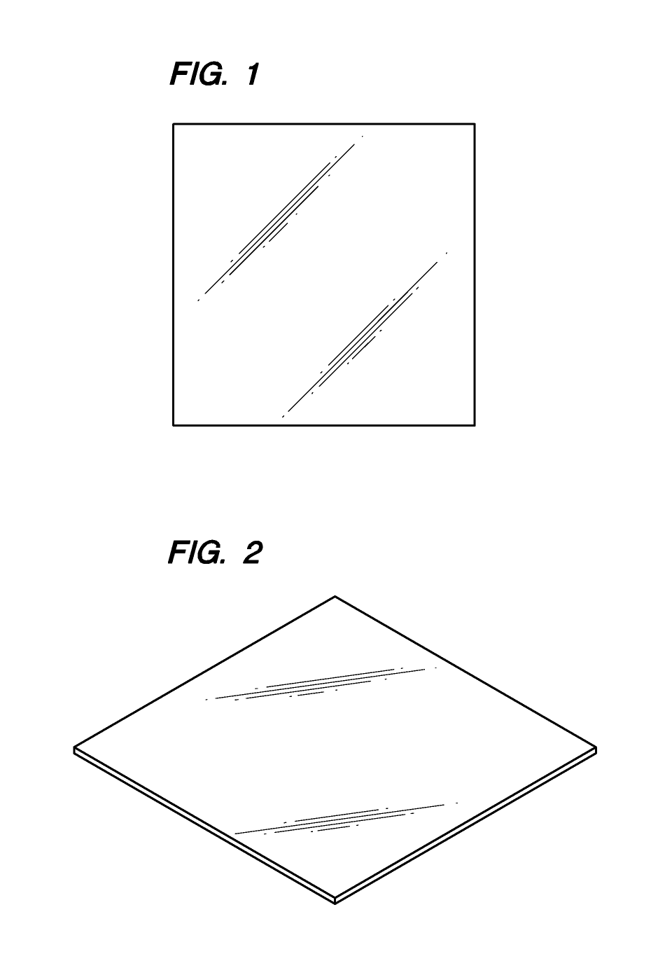

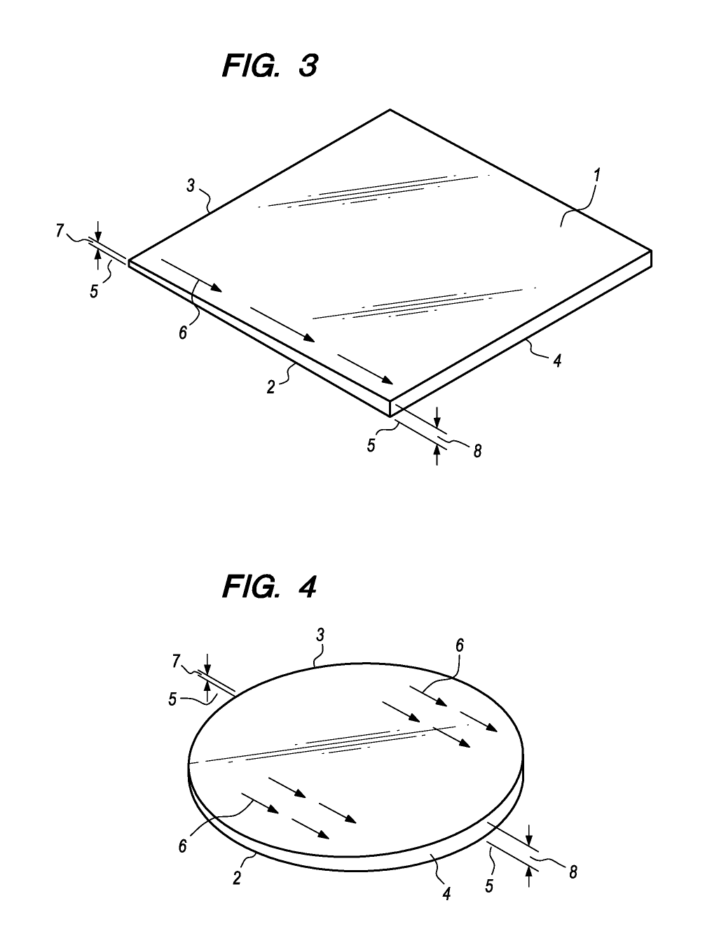

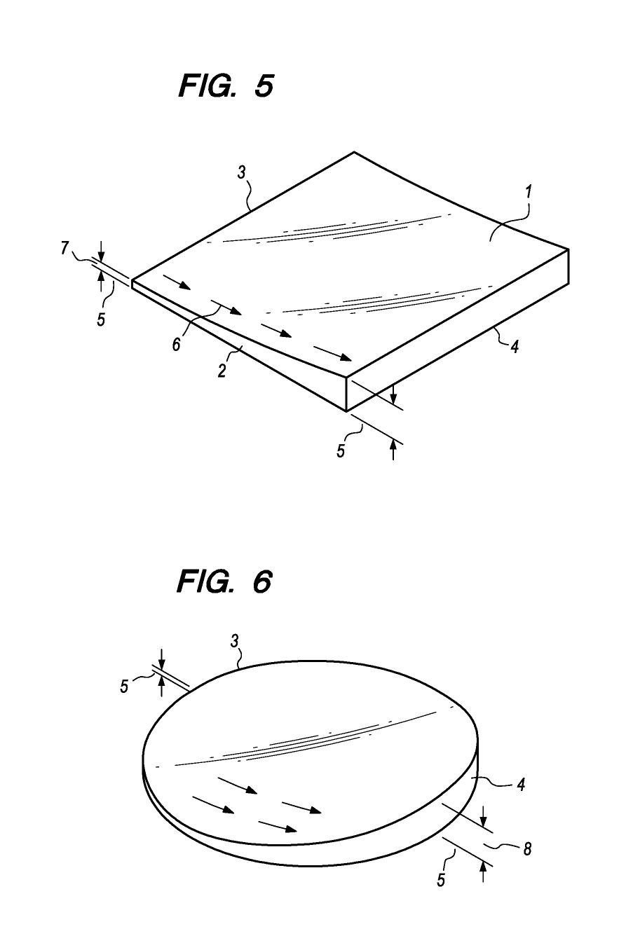

### DETAILED DESCRIPTION OF THE INVENTION

In the following detailed description of the preferred embodiment, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

The following is a listing of the reference numbers included in the original drawings and the element that each reference number corresponds to and a brief description:
1. A sheet of thermoplastic material
2. A thickness of the sheet of thermoplastic material.
3. A first end of the sheet of thermoplastic material
4. A second end of the sheet of thermoplastic
5. A gradient of thickness between the first end 3 and second end 4.
6. A visible indicator of the direction of the gradient of thickness.
7. A thickness of the first end 3 of the sheet of thermoplastic material 1.
8. A thickness of the second end 4 of the sheet of thermoplastic material 1.

The present invention includes a thermoplastic sheet 1 adapted for use in fabricating a removable dental retention and alignment device comprising a sheet of thermoplastic material having a thickness 2, wherein the thickness 2 of the thermoplastic sheet 1 is non-uniform. The sheet of thermoplastic material has a first end 3 and a second end 4; the first end has a first thickness 7; the second end 4 has a second thickness 8; the sheet of thermoplastic material has a gradient of thickness 5 between the first end and the second end. The thermoplastic sheet may also have a uniform gradient of thickness. The thermoplastic may also have a non-uniform thickness. The invention may optionally include a visible indicator 6 of the direction of the gradient of thickness.

The thermoplastic sheet may optionally comprise a square with sides measuring 120 or 125 millimeters 8. The thermoplastic sheet may have a first end with a thickness selected from the group consisting of 0.5 millimeters, 0.75 millimeters, 1.0 millimeters, 1.5 millimeters, 2.0 millimeters, and 3.0 millimeters, 4.0 millimeters, and 5.0 millimeters. The above quoted sizes are usable for the most commonly available vacuum form retainer fabrication machines. The sheet may also be circular. An another embodiment of the present invention comprises a method of fabricating a removable dental retention and alignment device comprising providing a thermoplastic sheet 1, wherein the thermoplastic sheet 1 has a first end 3 and a second end 4; the first end 3 has a first thickness 7; the second end 4 has a second thickness 8; the sheet of thermoplastic material has a gradient of thickness between the first end and the second end; heating the sheet to a soft state; optionally adapting the sheet to a stone model or other type of model of a set of teeth of a dental patient while the sheet is heated; then allowing the sheet to cool.

### Use of the Orthodontic Retainer of the Present Invention

Fabricating the appliance with the thicker end towards the posterior teeth will result in a retainer for open bite tendency patients. The thicker plastic between the posterior teeth with act as a bite block creating several millimeters of jaws separation just as acrylic retainers do. Except this retainer will cost much less and be much easier to fabricate than said acrylic retainer.

Fabricating the appliance with the thicker end towards the anterior, thick enough to disclude the posterior teeth result in a retainer for deep bite patients. The thicker plastic between the anterior teeth will help maintain the bite opening achieved during treatment by creating several millimeters of jaw separation just as retainers with an anterior bite plate do. This will facilitate the eruption of the posterior teeth and maintenance of the vertical position of the anterior teeth.

Fabricating the appliance with a resulting gradient which closely matches the natural gradient of bite opening will result in a retainer with no unequal distribution of occlusal force between the anterior and posterior teeth. In ideally finished cases, this will reduce the tendency for posterior open bites occurring due to excessive posterior occlusal forces on the retainer. This will distribute the forces of the occlusion more evenly and reduce wear and the tendency for the retainer to break. When the majority of the force is on posterior teeth as is the case with the current design, the retainer tends to flex as the teeth bite down, causing excess wear and a tendency for the retainer to break.

During normal closure the mandible follows a pathway determined by the individual's musculoskeletal matrix. The majority of the occlusal forces during closure and mastication fall on the posterior teeth, those teeth that are adapted for those forces. The anterior teeth are normally designated for making initial cuts into food otherwise known as incising the food.

Now Applicant would like to discuss an example Applicant is familiar with in his orthodontic practice of the shortcomings of the prior art. A patient who has been wearing a 0.040″ clear thermoplastic suck-down retainer for approximately 22 hours per day for over 3 months was examined. The teeth were dried and the patient was asked to bite directly down on occlusion indicating paper on all areas of his occlusion prior to the occlusal photos. The red and blue marks indicate occlusal contacts, larger marks indicating heavier occlusal contacts. This patient has no contact of his posterior teeth.

The loss of contact of posterior teeth is a common side effect of Essix retainer wear. This is due to the natural jaw position and the tendency for the jaw to want to return to its baseline mandibular plane angle or rest position. Because the jaw wants to rest with unequal space between the anterior and posterior teeth, the thickness of the Essix plastic in the posterior region causes intrusion of the posterior teeth. Thus, there is loss of occlusal contact.

This illustrates the problems associated with prescription of the currently used suck-down retainer. Contact of the upper and lower teeth is only occurring on the anterior teeth. Yet we know the posterior teeth are more suited for the occlusal forces of mastication.

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given.

What is claimed is:

1. A thermoplastic sheet adapted for use in fabricating a removable dental retention and alignment device comprising:
a. a sheet of thermoplastic material having a thickness;
b. wherein the thickness of the thermoplastic sheet is non-uniform.

2. The thermoplastic sheet of claim 1, wherein:
a. the sheet of thermoplastic material has a first end and a second end;
b. the first end has a first thickness;
c. the second end has a second thickness;
d. the sheet of thermoplastic material has a gradient of thickness between the first end and the second end.

3. The thermoplastic sheet of claim 2, wherein the gradient of thickness is uniform.

4. The thermoplastic sheet of claim 2, wherein the gradient of thickness is non-uniform.

5. The thermoplastic sheet of claim 2, further comprising a visible indicator of the direction of the gradient of thickness.

6. The thermoplastic sheet of claim 2, wherein the sheet of thermoplastic material comprises a square with sides measuring 120 millimeters.

7. The thermoplastic sheet of claim 2, wherein the sheet of thermoplastic material comprises a square with sides measuring 125 millimeters.

8. The thermoplastic sheet of claim 2, wherein the first end has a thickness of selected from the group consisting of 0.5 millimeters, 0.75 millimeters, 1.0 millimeters, 1.5 millimeters, 2.0 millimeters, and 3.0 millimeters, 4.0 millimeters, and 5.0 millimeters, 6.0 millimeters, and 8.0 millimeters.

9. The thermoplastic sheet of claim 2, wherein the sheet is circular.

10. The thermoplastic sheet of claim 2, wherein the sheet is rectangular.

11. A method of fabricating a removable dental retention and alignment devices comprising:
a. Providing a thermoplastic sheet, wherein the thermoplastic sheet
i. has a first end and a second end;
ii. the first end has a first thickness;
iii. the second end has a second thickness;
iv. the sheet of thermoplastic material has a gradient of thickness between the first end and the second end.
b. heating the sheet to a soft state;
c. adapting the sheet to a model of a set of teeth of a dental patient while the sheet is heated;
d. allowing the sheet to cool.

12. The method of claim 11, wherein the model is a stone model.

13. The method of claim 11, wherein the gradient of thickness is uniform.

14. The method of claim 11, wherein the gradient of thickness is non-uniform.

15. The method of claim 11, further comprising a visible indicator of the direction of the gradient of thickness.

16. The method of claim 11, wherein the sheet of thermoplastic material comprises a square with sides measuring 120 millimeters.

17. The method of claim 11, wherein the sheet of thermoplastic material comprises a square with sides measuring 125 millimeters.

18. The method of claim 11, wherein the first end has a thickness of selected from the group consisting of 0.5 millimeters, 0.75 millimeters, 1.0 millimeters, 1.5 millimeters, 2.0 millimeters, and 3.0 millimeters, 4.0 millimeters, and 5.0 millimeters.

19. The method of claim 11, wherein the sheet is circular.

20. The method of claim 11, wherein the sheet is rectangular.
